(19) United States
(12) Patent Application Publication
(10) Pub. No.: US 2016/0171180 A1
(43) Pub. Date: Jun. 16, 2016

(54) INCENTIVIZED WELLNESS BEHAVIOR MODIFICATION

(71) Applicant: Verizon Patent and Licensing Inc., Arlington, VA (US)

(72) Inventors: Sai Sarath Chandra YAGNYAMURTHY, Bridgewater, NJ (US); Nitesh JAIN, East Windsor, NJ (US); Jean Francois DUBOIS, Boothbay Harbor, ME (US)

(21) Appl. No.: 14/567,323

(22) Filed: Dec. 11, 2014

(51) Int. Cl. G06F 19/00

(52) U.S. Cl. CPC G06F 19/36; G06F 19/3431; G06F 19/3443

(57) ABSTRACT

A device receives healthcare information that includes information associated with a health of a user. The healthcare information is received from a multiple devices that monitor the health of the user and/or store information regarding the health of the user. The device performs an analysis of the healthcare information via one or more analytics techniques, and identifies a type of health-related motivation, from multiple types of health-related motivations, based on performing the analysis. The device provides the type of health-related motivation to a user device associated with the user.

### BACKGROUND

Users today utilize a variety of user devices, such as cell phones, smart phones, tablet computers, or the like, to access healthcare information, monitor user vital signs, and/or perform other tasks. Users may also utilize home monitoring systems that include personal monitoring devices (e.g., heart rate monitors, blood pressure monitors, or the like) for monitoring user vital signs.

Healthcare providers, such as doctors, pharmacies, hospitals, nursing homes, or the like, provide a variety of healthcare services to particular users (e.g., patients) and may collect a variety of healthcare information about the users. Furthermore, many healthcare providers maintain a database of electronic health records (EHRs) for their users' healthcare information. The healthcare information may include, for example, discharge summaries when users are discharged from a hospital; reasons for a referral; consultant reports to referring doctors; medication lists; imaging test results; lab results; a care plan from specialists; discharge instructions; a list of follow-up appointments, procedures, tests, and referrals; a medication allergy list; mental health information; a problem list; vital sign readings from home monitors and/or user devices; or the like.

### BRIEF DESCRIPTION OF THE DRAWINGS

FIGS. 1A and 1B are diagrams of an overview of an example implementation described herein;

FIG. 2 is a diagram of an example environment in which systems and/or methods, described herein, may be implemented;

FIG. 3 is a diagram of example components of a device that may correspond to one or more of the devices of the environment depicted in FIG. 2;

FIG. 4 is a flow chart of an example process for receiving and configuring a wellness application for a user device;

FIGS. 5A and 5B are diagrams of example user interfaces that may be used in connection with the example process shown in FIG. 4;

FIG. 6 is a flow chart of an example process for modifying wellness behavior of a user based on incentives, gaming information, and/or coaching; and

FIGS. 7A-7F are diagrams of an example relating to the example process shown in FIG. 6.

### DETAILED DESCRIPTION OF PREFERRED EMBODIMENTS

The following detailed description refers to the accompanying drawings. The same reference numbers in different drawings may identify the same or similar elements.

Current healthcare information collection systems are not interconnected and do not provide a single repository for healthcare information associated with users. For example, healthcare information, for a particular user, collected by a user device is not associated with healthcare information collected by hospitals, home monitoring systems, pharmacies, or the like. Furthermore, most healthcare information about users is collected using high-cost personal monitoring equipment at hospitals, in homes, at doctors' offices, or the like.

Users may utilize portions of the healthcare information to keep track of their wellness (e.g., a healthy balance of mind, body, and spirit that results in an overall feeling of well-being). For example, a user may utilize a wearable device to keep track of distances run by the user. However, the same user may not use the wearable device to keep track of poor dietary foods eaten by the user, which may offset the exercise engaged in by the user. The user may also track the poor dietary foods eaten by the user with another device, but such information may not be aggregated with the running distances tracked by the wearable device. Thus, the portions of the healthcare information tracked by the user may not provide a complete wellness picture for the user. Furthermore, the portions of the healthcare information may not provide wellness incentives to the user.

Systems and/or methods, described herein, may provide a wellness program that changes a user's feelings toward wellness using virtual reality and/or augmented reality. The systems and/or methods may provide a single location for the user's healthcare information, and may utilize the healthcare information to provide health-related motivations, such as incentives, coaching, gaming information, or the like to the user. The systems and/or methods may encourage the user to engage in and stick with the wellness program, which may lead to a happier, healthier, and/or more productive user.

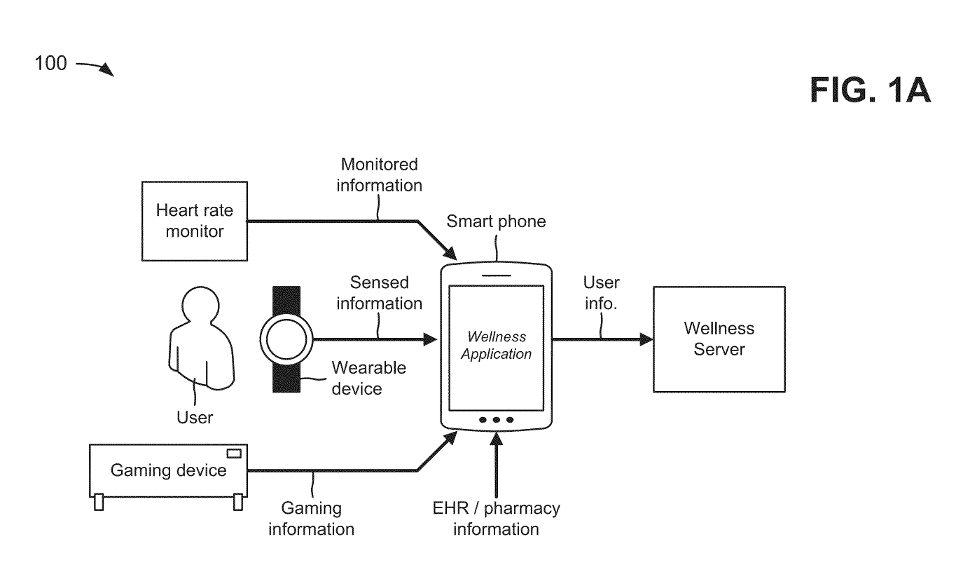

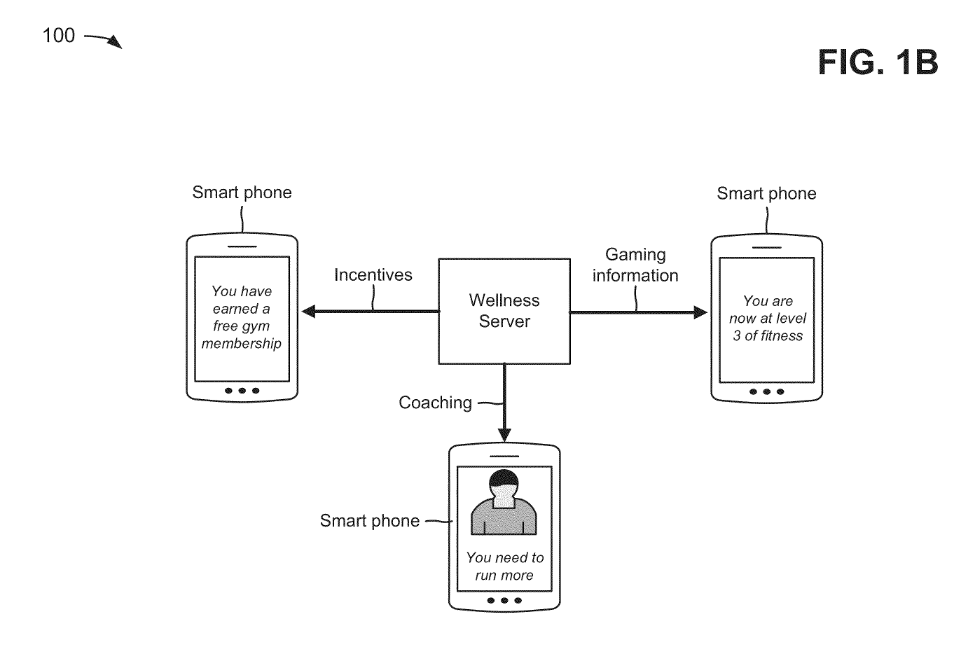

FIGS. 1A and 1B are diagrams of an overview of an example implementation 100 described herein. As shown in FIG. 1A, assume that a heart rate monitor (e.g., associated with a home monitoring system), a wearable device (e.g., a fitness watch), a gaming device, and/or a smart phone are associated with a user. As further shown in FIG. 1A, the heart rate monitor may generate monitored information (e.g., relating to a heart rate of the user), the wearable device may generate sensed information (e.g., relating to a number of steps taken by the user in a period of time), and/or the gaming device may generate gaming information (e.g., information associated with a fitness game utilized by the user). The monitored information, the sensed information, and/or the gaming information may be received by a wellness application provided on the smart phone.

As further shown in FIG. 1A, the wellness application may receive an EHR of the user and pharmacy information associated with the user from a device that maintains such information (e.g., a device at a healthcare provider). The EHR/pharmacy information may include information, such as discharge summaries, referral information, consultant reports, medication lists, test results, lab results, medication allergy lists, vital sign readings, mental health information, or the like, associated with the user. In some implementations, the monitored information, the sensed information, the gaming information, the EHR/pharmacy information may be referred to collectively as healthcare information associated with the user.

As further shown in FIG. 1A, the smart phone may provide user information to a wellness server. The user information may include the user's healthcare information, location information associated with the user (e.g., indicating that the user spends a lot of time in certain locations), demographic information associated with the user, dietary information associated with the user (e.g., indicating that the user eats certain foods), or the like. The wellness server may receive the user information from the smart phone, and may perform an analysis of the user information, in near real time (e.g., real time or approximately real time), real time, or batch time, via pattern recognition, hidden Markov modeling, trending, prediction, segmentation, or the like. The wellness server may generate information for the user (e.g., a wellness score for the user) based on the analysis of the user information.

As shown in FIG. 1B, the wellness server may generate health-related incentives (e.g., a free gym membership) for the user based on the analysis of the user information. The wellness server may provide the health-related incentives, for display, to the smart phone. The wellness server may generate health-related gaming information (e.g., a new level obtained for a fitness game) for the user based on the analysis of the user information. The wellness server may provide the health-related gaming information, for display, to the smart phone. The wellness server may generate health-related coaching information (e.g., a virtual coach that instructs the user to exercise more) for the user based on the analysis of the user information. The wellness server may provide the health-related coaching information, for display, to the smart phone.

Systems and/or methods, described herein, may provide a framework for modifying wellness behavior of a user. The systems and/or methods may provide a single location for storage and retrieval of healthcare information associated with the user, and may provide monetary and non-monetary incentives to motivate the user to engage in healthy behavior. The systems and/or methods may provide real or virtual health coaching to further motivate the user to engage in healthy behavior, and may utilize gaming to create health-related competition for the user with other users. By improving the wellness of the user, the systems and/or methods may significantly reduce healthcare costs for users, employers of the users, healthcare providers, insurance providers, or the like.

The term entity, as used herein, is intended to be broadly interpreted to include a business, an organization, a government agency, a healthcare provider, a user device, a user of a user device, or the like.

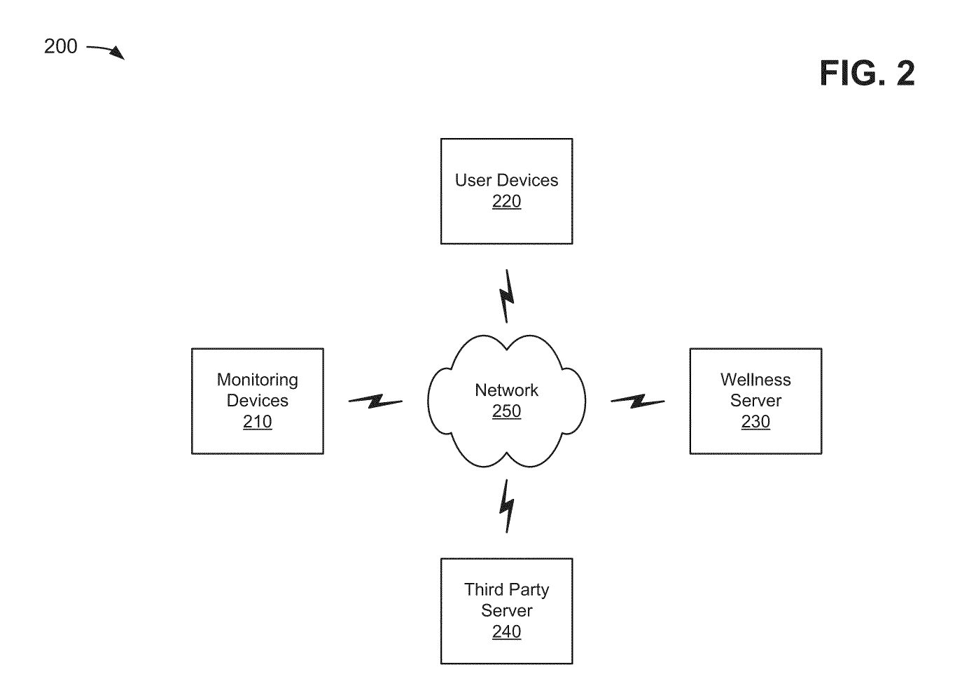

FIG. 2 is a diagram of an example environment 200 in which systems and/or methods, described herein, may be implemented. As illustrated, environment 200 may include monitoring devices 210 (referred to collectively as “monitoring devices 210,” and individually as “monitoring device 210”), user devices 220 (referred to collectively as “user devices 220,” and individually as “user device 220”), a wellness server 230, a third party server 240, and a network 250. Devices/networks of environment 200 may interconnect via wired connections, wireless connections, or a combination of wired and wireless connections.

Monitoring device 210 may include a device that is capable of monitoring a physical characteristic of a user, a condition associated with a user, or the like. In some implementations, monitoring device 210 may include a blood pressure monitor, a heart rate monitor, a scale, an electrocardiogram (ECG) monitor, a blood oxygen saturation level monitor, a pedometer, or the like. In some implementations, monitoring device 210 may wirelessly communicate over network 250 with user device 220 and/or wellness server 230.

User device 220 may include a device that is capable of communicating over network 250 with wellness server 230. In some implementations, user device 220 may include a radiotelephone; a personal communications services (PCS) terminal that may combine, for example, a cellular radiotelephone with data processing and data communications capabilities; a smart phone; a television; a laptop computer; a tablet computer; a global positioning system (GPS) device; a gaming device; a set-top box (STB); or another type of computation and communication device. In some implementations, user device 220 may include one or more monitoring devices 210 that monitor vital signs of a user, such as, for example, a heart rate monitor, an ECG monitor, a pedometer, or the like. In some implementations, user device 220 may include a wellness application that receives user information associated with a user (e.g., healthcare information, location information, demographic information, dietary information, or the like, associated with the user), and provides the user information to wellness server 230.

Wellness server 230 may include one or more personal computers, one or more workstation computers, one or more server devices, one or more virtual machines (VMs) provided in a cloud computing environment, or one or more other types of computation and communication devices. In some implementations, wellness server 230 may be associated with an entity that manages and/or operates network 250, such as, for example, a telecommunication service provider, a television service provider, an Internet service provider, or the like. In some implementations, wellness server 230 may be associated with one or more healthcare providers.

In some implementations, wellness server 230 may receive user information (e.g., healthcare information, location information, demographic information, or the like associated with a user) from user device 220. In some implementations, a device may be provided in network 250 to detect the user information, and to provide the user information to wellness server 230. Wellness server 230 may perform an analysis of the received user information, in near real time, real time, or batch time, via pattern recognition, hidden Markov modeling, trending, prediction, segmentation, or the like. In some implementations, wellness server 230 may generate health-related motivations, such as health-related incentives, gaming information, coaching information, or the like based on the analysis of the received user information, and may provide the health-related incentives, gaming information, and/or coaching information, for display, to user device 220.

In some implementations, wellness server 230 may determine whether a wellness behavior of the user is modified based on the health-related incentives, gaming information, and/or coaching information. If the wellness behavior of the user is not modified, wellness server 230 may modify the health-related incentives, gaming information, and/or coaching information, and may provide the modified health-related incentives, gaming information, and/or coaching information, for display, to user device 220. In some implementations, wellness server 230 may perform operations described herein in accordance with particular regulations (e.g., Health Insurance Portability and Accountability Act (HIPAA) regulations, privacy regulations, or the like). In some implementations, the healthcare information and/or communications among the devices of FIG. 2 may be encrypted to protect the information and/or the communications.

Third party server 240 may include one or more personal computers, one or more workstation computers, one or more server devices, one or more VMs provided in a cloud computing environment, or one or more other types of computation and communication devices. In some implementations, third party server 240 may include one or more data structures, such as databases, tables, lists, arrays, or the like. In some implementations, third party server 240 may store information used to identify and/or authenticate users, healthcare information, information associated with particular regulations (e.g., HIPAA regulations), or the like. In some implementations, the information used to identify and/or authenticate users may include agreements (e.g., business associate agreements) entered into by the users with wellness server 230; license information (e.g., drivers license numbers, medical license numbers, or the like) associated with the users; demographic information (e.g., name, address, telephone number, age, or the like) associated with the users; or the like. In some implementations, third party server 240 may be associated with one or more healthcare providers, insurance companies, employers, or the like.

Network 250 may include a network, such as a local area network (LAN), a wide area network (WAN), a metropolitan area network (MAN), a telephone network, such as the Public Switched Telephone Network (PSTN) or a cellular network, an intranet, the Internet, a fiber optic network, a cloud computing network, or a combination of networks.

The number and arrangement of devices and/or networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

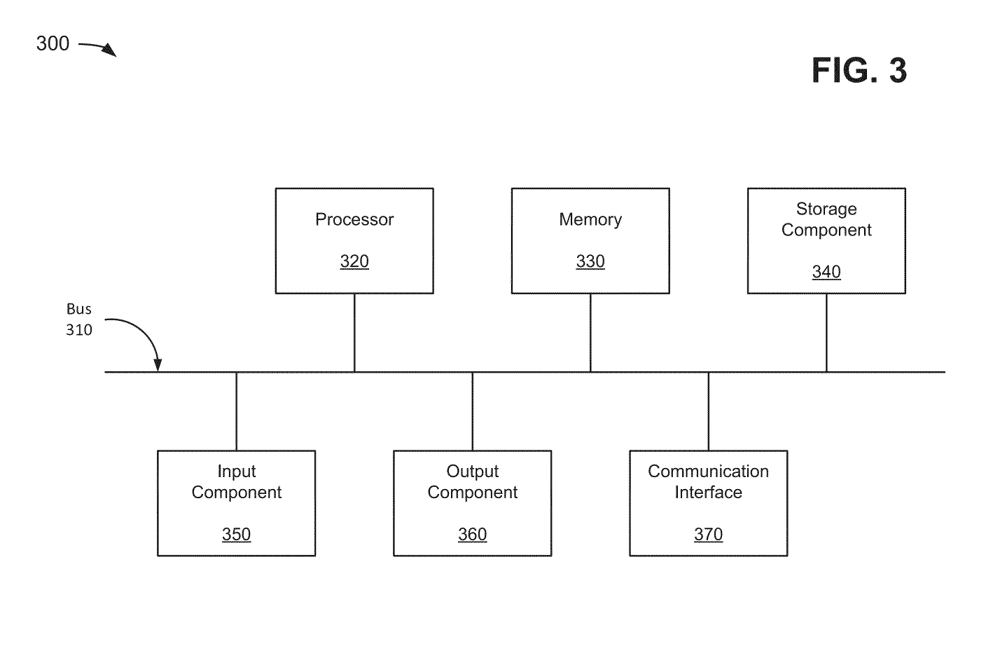

FIG. 3 is a diagram of example components of a device 300. Device 300 may correspond to monitoring device 210, user device 220, wellness server 230, and/or third party server 240. In some implementations, monitoring device 210, user device 220, wellness server 230, and/or third party server 2400 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 may include a component that permits communication among the components of device 300. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 350 may include a component that permits device 300 to receive information, such as via user input (e.g., a touch screen display, a keyboard, a keypad, a mouse, a button, a switch, a microphone, etc.). Additionally, or alternatively, input component 350 may include a sensor for sensing information (e.g., a global positioning system (GPS) component, an accelerometer, a gyroscope, an actuator, etc.). Output component 360 may include a component that provides output information from device 300 (e.g., a display, a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

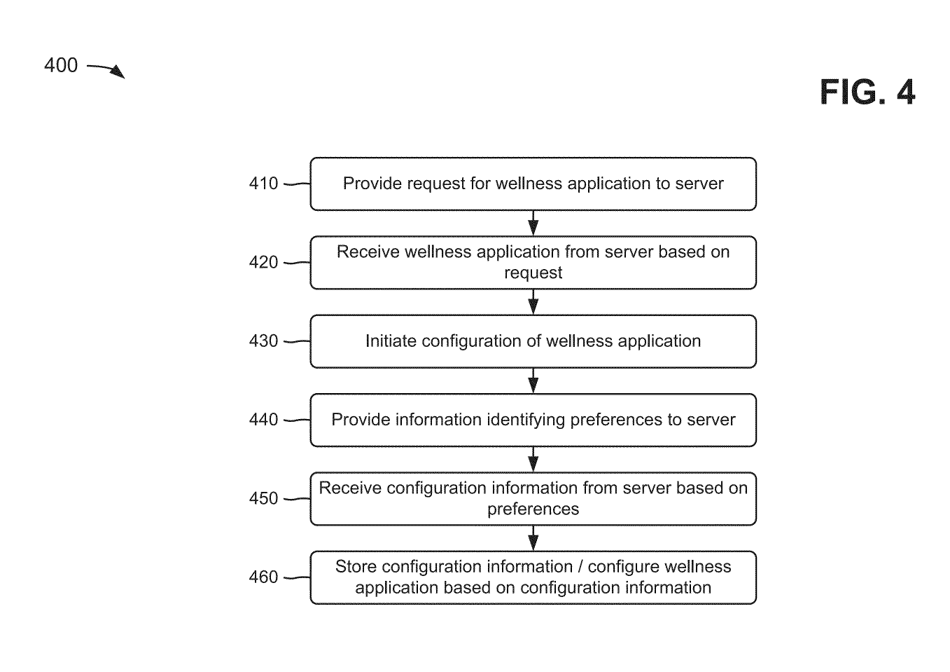

FIG. 4 is a flow chart of an example process 400 for receiving and configuring a wellness application for a user device. In some implementations, one or more process blocks of FIG. 4 may be performed by user device 220. In some implementations, one or more process blocks of FIG. 4 may be performed by another device or a group of devices separate from or including user device 220, such as wellness server 230.

As shown in FIG. 4, process 400 may include providing a request for a wellness application to a server (block 410). For example, a user may cause user device 220 to provide a request for a wellness application to wellness server 230. In some implementations, the wellness application may include an application, a code snippet, a script, a widget, or the like that causes user device 220 to perform one or more functions. For example, the wellness application may enable the user to set preferences for receiving user information (e.g., healthcare information, location information, demographic information, or the like), associated with monitoring devices 210, user devices 220, and/or third party server 240, and providing the information to wellness server 230. In some implementations, the user may cause user device 220 to access the wellness application via, for example, a user interface (such as a browser) provided by wellness server 230, or in another manner. The user may then select, using user device 220, information regarding the wellness application from the user interface to cause user device 220 to provide a request for the wellness application to wellness server 230. In some implementations, wellness server 230 may offer the wellness application to user device 220 without user device 220 providing the request for the wellness application.

As further shown in FIG. 4, process 400 may include receiving the wellness application from the server based on the request (block 420). For example, user device 220 may receive the wellness application from wellness server 230, and may store the wellness application in a memory associated with user device 220 (e.g., memory 330, FIG. 3). In some implementations, the user, of user device 220, may establish an account associated with the wellness application prior to or after receiving the wellness application. In some implementations, the wellness application may be stored in wellness server 230 (e.g., and not in user device 220), and user device 220 may access the wellness application via login credentials associated with the user's account.

As further shown in FIG. 4, process 400 may include initiating a configuration of the wellness application (block 430). For example, the user may initiate the wellness application and identify, using user device 220, one or more preferences relating to receiving and/or utilizing user information associated with monitoring devices 210, user devices 220, and/or third party server 240. In some implementations, the user may identify the one or more preferences using one or more elements of a user interface provided by user device 220 and/or wellness server 230. The one or more elements may include, for example, one or more text input elements, one or more drop down menu elements, one or more checkbox elements, one or more radio button elements, and/or any other types of elements that may be used to receive information from the user.

Alternatively, or additionally, the one or more preferences may include a preference of the user with respect to the wellness application providing wellness server 230 with access to location information, health application information, monitored information, sensed information, EHRs, medications, virtual wallet information, or the like received by user device 220. For example, user device 220 (e.g., via the wellness application) may receive monitored information from monitoring devices 210 associated with a user, sensed information from user device 220 and/or other user devices 220, EHR and/or medications information from third party server 240, and may store the received information. In another example, user device 220 may receive location information associated with user device 220 (e.g., via a GPS sensor), may access a virtual wallet or other electronic payment applications, may store user demographic information, or the like.

Alternatively, or additionally, the one or more preferences may include a preference of the user with respect to the wellness application providing wellness incentives to the user of user device 220. For example, in order to encourage the user to engage in healthy behavior, the wellness application may provide monetary incentives to the user, such as gift cards, insurance premium reductions, subsidies from employers, third parties, and/or insurers, or the like. In another example, the wellness application may provide non-monetary incentives to the user, such as points for doing activities the user enjoys, a free user device, a gym membership, access to a new fitness game, access to a new level of the fitness game, a badge, a medal, or another award for accomplishing a goal or objective, or the like.

Alternatively, or additionally, the one or more preferences may include a preference of the user with respect to the wellness application providing gaming information to the user of user device 220. For example, the user may indicate that the wellness application is to provide gaming information (e.g., a fitness application, a fitness game, a level achieved in the fitness application and/or fitness game, or the like) to the user. In another example, the user may indicate that the wellness application is to share the gaming information with other users. In still another example, the user may indicate that the wellness application is to link game levels with the incentives provided by the wellness application.

Alternatively, or additionally, the one or more preferences may include a preference of the user with respect to the wellness application providing the user with access to a health coach to aid the user in achieving wellness goals. For example, the user may indicate that the wellness application is to provide the user with access to a virtual health coach. In another example, the user may indicate that the wellness application is to provide the user with access to a real health coach.

Alternatively, or additionally, the one or more preferences may include a preference of the user with respect to the wellness application sending notifications associated with the user's wellness. For example, the user may indicate that the wellness application is to send notifications to the user or to another user associated with the user (e.g., via a text message, an email message, a voicemail message, a voice call, or the like).

Alternatively, or additionally, a type of the account, of the user, associated with the wellness application may determine the quantity of preferences that the user is able to specify. For example, the wellness application may enable the user to specify only a portion of the above preferences or specify additional preferences based on the type of the account with which the user is associated.

As further shown in FIG. 4, process 400 may include providing information identifying one or more preferences to the server (block 440). For example, the user may cause user device 220 to provide, to wellness server 230, information identifying the one or more preferences relating to the user and provided during the configuration of the wellness application.

As further shown in FIG. 4, process 400 may include receiving configuration information from the server based on the preferences (block 450). For example, user device 220 may receive, from wellness server 230, configuration information that may be used to configure the wellness application to receive information associated with monitoring devices 210, user devices, and/or third party server 240.

In some implementations, wellness server 230 may generate the configuration information, which may be used to configure the wellness application, based on the information identifying the one or more preferences of the user. For example, the configuration information may include information that causes the wellness application to receive and/or utilize user information associated with monitoring devices 210, user devices 220, and/or third party server 240.

Alternatively, or additionally, the configuration information may include information that causes wellness server 230 to receive access to the location information, the health application information, the monitored information, the sensed information, the EHR, the medications information, the virtual wallet information, or the like associated with the user of user device 220. Alternatively, or additionally, the configuration information may include information that causes wellness server 230 to provide monetary and/or non-monetary wellness incentives to the user of user device 220.

Alternatively, or additionally, the configuration information may include information that causes wellness server 230 to provide gaming information to the user of user device 220, to share the gaming information with another user, to link game levels with health incentives, or the like. Alternatively, or additionally, the configuration information may include information that causes wellness server 230 to provide the user with access to a virtual health coach, a real health coach, or the like. Alternatively, or additionally, the configuration information may include information that causes wellness server 230 to send notifications (e.g., to the user and/or to another user another device other than user device 220) associated with the wellness of the user.

Alternatively, or additionally, the configuration information may be obtained from a data structure. In some implementations, wellness server 230 may provide, to user device 220, the configuration information independent of receiving the information identifying the one or more preferences of the user.

As further shown in FIG. 4, process 400 may include storing the configuration information and configuring the wellness application based on the configuration information (block 460). For example, the user may cause user device 220 to store all or a portion of the configuration information received from wellness server 230. The wellness application may be configured based on storing all or a portion of the configuration information. In some implementations, wellness server 230 may store all or a portion of the configuration information.

In some implementations, wellness server 230 may provide updates, to the configuration information, to user device 220 based on use of the wellness application by user device 220 and/or by other user devices 220. For example, wellness server 230 may receive updates, to the configuration information, from the user and may provide the received updates to user device 220. User device 220 may store the updates to the configuration information. In some implementations, wellness server 230 may provide the updates periodically based on a preference of the user and/or based on a time frequency determined by wellness server 230. In some implementations, wellness server 230 may determine whether to provide the updates based on the type of the account associated with the user.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

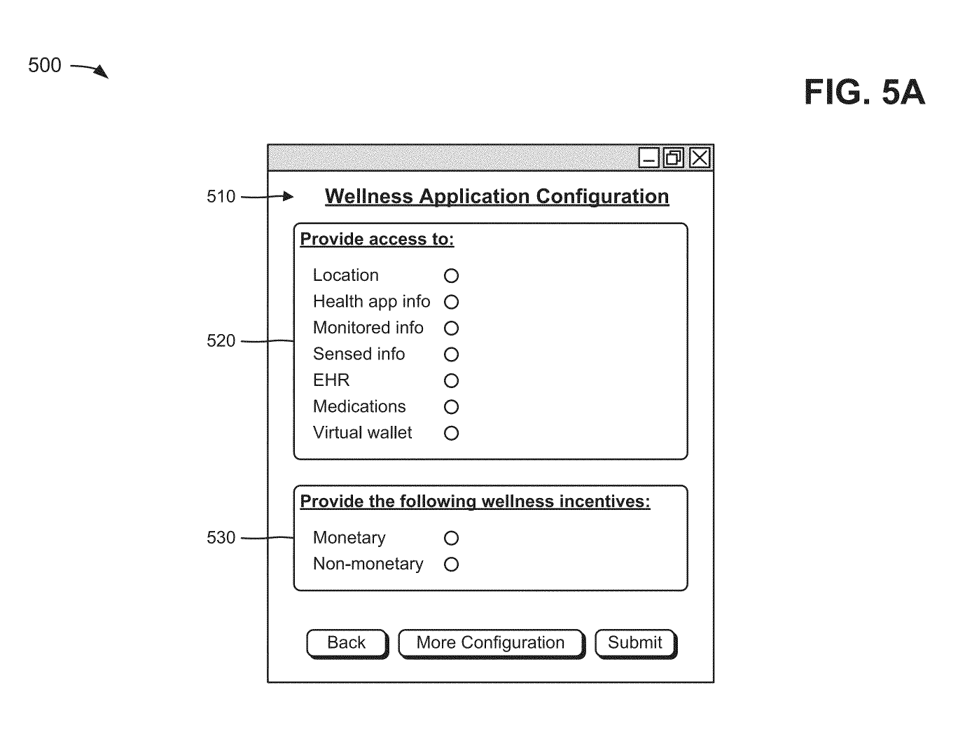

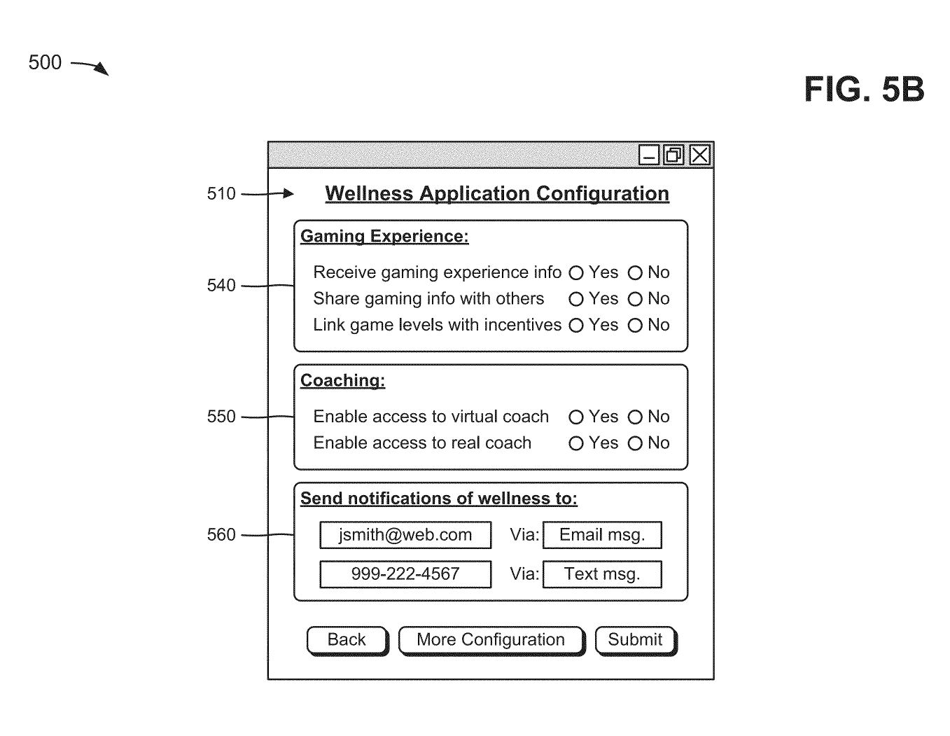

FIGS. 5A and 5B are diagrams 500 of example user interfaces that may be used in connection with example process 400 shown in FIG. 4. In some implementations, the user interfaces of FIGS. 5A and 5B may be provided by wellness server 230 to user device 220 to enable a user to identify information (e.g., preferences) that may be used to configure the wellness application so that user device 220 receives information associated with monitoring devices 210, user devices 220, wellness server 230, and/or third party server 240.

Assume that the user has previously caused user device 220 to request and download the wellness application or to log into an account associated with the wellness application. Further assume that the user causes user device 220 to install the wellness application on user device 220. When the user logs into the account or user device 220 installs the wellness application, as shown in FIG. 5A, wellness server 230 may provide a user interface 510 to user device 220, and user device 220 may display user interface 510 to the user. User interface 510 may allow the user to configure different features of the wellness application. For example, the user may identify preferences for providing wellness server 230 with access to the location information, the health application information, the monitored information, the sensed information, the EHR, the medications information, the virtual wallet information, or the like, in a first configuration section 520. In some implementations, the user may indicate that the user wants wellness server 230 to receive access to all information received by the wellness application. In some implementations, the user may indicate that the user wants wellness server 230 to receive access to of the location information, the health application information, the monitored information, the sensed information, the EHR, the medications information, and/or the virtual wallet information.

As further shown in FIG. 5A, the user may identify preferences for providing wellness incentives to the user, in a second configuration section 530. In some implementations, the user may indicate that the user wants the wellness application to provide monetary wellness incentives to the user. In some implementations, the user may indicate that the user wants the wellness application to provide non-monetary wellness incentives to the user. In some implementations, the user may indicate that the user wants the wellness application to provide monetary wellness incentives and non-monetary wellness incentives to the user.

As shown in FIG. 5B, the user may identify preferences for providing gaming information to the user, in a third configuration section 540. In some implementations, the user may indicate that the user wants the wellness application to provide the gaming information to the user (e.g., to user device 220 and/or another user device 220 associated with the user, such as a gaming device). In some implementations, the user may indicate that the user wants the wellness application to share the gaming information with other users. For example, the user may wish to compete with other users in a fitness challenge, and may share the gaming information with the other users so that a comparison may be made with the fitness of the other users. In some implementations, the user may indicate that the user wants the wellness application to link game levels with the wellness incentives provided by the wellness application. For example, if the user achieves a certain level in a fitness game, the wellness application may reward the user with a wellness incentive.

As further shown in FIG. 5B, the user may identify preferences for providing coaching information to the user, in a fourth configuration section 550. In some implementations, the user may indicate that the user wants the wellness application to provide the user with access to a virtual health coach. In some implementations, the user may indicate that the user wants the wellness application to provide the user with access to a real health coach. For example, the user may wish to receive encouragement and/or guidance from a fitness professional regarding weight training, and the wellness application may provide the user with access to a virtual or real fitness professional to instruct the user on proper weight training.

As further shown in FIG. 5B, the user may identify preferences for sending notifications about the user's wellness, in a fifth configuration section 560. In some implementations, the user may indicate that the user wants the wellness application to provide a notification about the user's wellness to one or more users associated with user device 220 and may indicate a notification method (e.g., send a notification to “jsmith@web.com” via an email message and send a notification to “999-222-4567” via a text message). In some implementations, the user may indicate that the user wants the wellness application to provide a notification about the user's wellness to one or more other users.

Once the user has identified the preferences, user interface 510 may allow the user to select a “Submit” option to store the preferences and/or submit the preferences to wellness server 230. Wellness server 230 may then provide, to user device 220, configuration information based on the preferences.

As further shown in FIGS. 5A and 5B, user interface 510 may also allow the user to select a “Back” option to cause user device 220 to provide information regarding the wellness application. As also shown in FIGS. 5A and 5B, user interface 510 may also allow the user to select a “More Configuration” option to enable the user to identify additional information that may be used to configure the wellness application.

The number of elements of user interface 510 shown in FIGS. 5A and 5B is provided for explanatory purposes. In practice, user interface 510 may include additional elements, fewer elements, different elements, or differently arranged elements than those shown in FIGS. 5A and 5B.

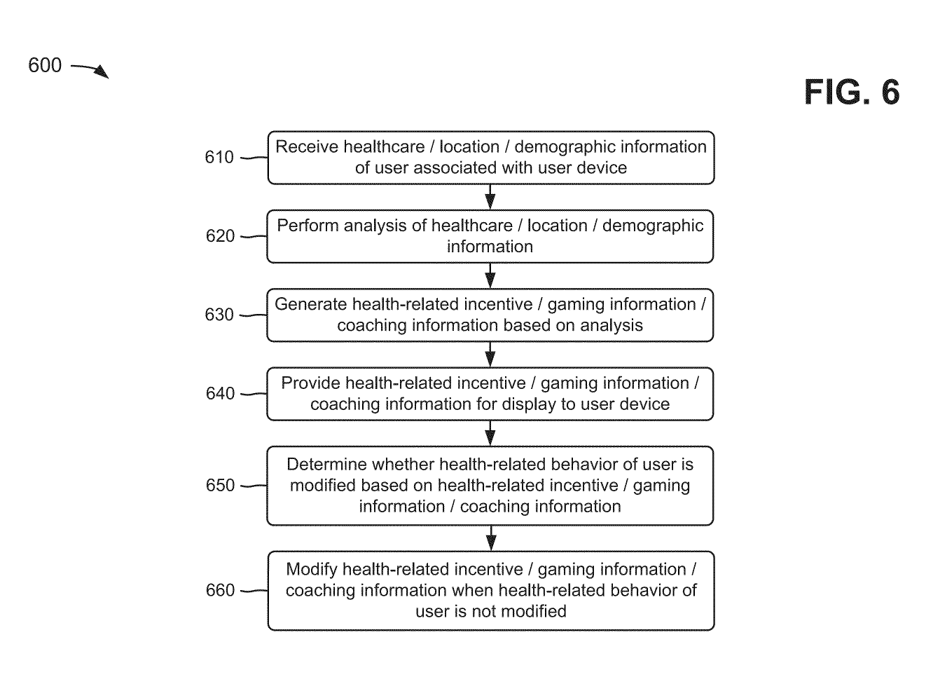

FIG. 6 is a flow chart of an example process 600 for modifying wellness behavior of a user based on incentives, gaming information, and/or coaching. In some implementations, one or more process blocks of FIG. 6 may be performed by wellness server 230. In some implementations, one or more process blocks of FIG. 6 may be performed by another device or a group of devices separate from or including wellness server 230, such as user device 220.

As shown in FIG. 6, process 600 may include receiving healthcare information, location information, and/or demographic information of a user associated with a user device (block 610). For example, wellness server 230 may receive healthcare information, location information, demographic information, or the like (e.g., collectively referred to herein as “user information”) associated with a user of user device 220. In some implementations, the user information may include social media information (e.g., social media account information, information posted to a social media account, or the like); purchase habits (e.g., restaurants frequented, food purchases, tobacco purchases, alcohol purchases, or the like via a virtual wallet); or the like, associated with the user. In some implementations, the wellness application of user device 220 may receive the user information, and may periodically provide the user information to wellness server 230 (e.g., at particular intervals, at designated times, or the like). In some implementations, the wellness application may continuously provide the user information to wellness server 230. In some implementations, the wellness application may provide the user information to wellness server 230 when requested by wellness server 230. In some implementations, the wellness application may provide the user information to wellness server in an encrypted manner.

In some implementations, one or more monitoring devices 210, user devices 220, and/or third party servers 240 may generate healthcare information, and may provide the healthcare information to user device 220. In some implementations, user device 220 may be configured to monitor and route the healthcare information (or a copy of the healthcare information) to wellness server 230. The healthcare information may include, for example, blood pressure readings of the user, heart rate readings of the user, other vital sign readings of the user, discharge summaries associated with the user, referrals for the user, consultant reports for the user, medication lists of the user, test results of the user, lab results of the user, procedures for the user, a medication allergy list of the user, eating habits of the user, exercise habits of the user, or the like.

In some implementations, user device 220 may be configured to monitor and route the location information (or a copy of the location information) to wellness server 230. The location information may include, for example, latitude and longitude coordinates associated with user device 220, GPS coordinates associated with user device 220, or the like. In some implementations, network 250 may determine a location of user device 220 based on triangulation of signals, generated by user device 220 and received by multiple base stations, with prior knowledge of the base stations. In some implementations, network 250 may include a space-based satellite navigation system (e.g., a global positioning system (GPS)) that provides location information (e.g., GPS coordinates) associated with user device 220.

In some implementations, user device 220 may be configured to monitor and route the demographic information (or a copy of the demographic information) to wellness server 230. The demographic information may include, for example, a name, an address, a telephone number, an age, a height, a weight, smoking habits (e.g., via tobacco purchases with a virtual wallet), an income level, or the like, associated with the user.

In some implementations, wellness server 230 may preprocess the user information utilizing feature selection (e.g., a process of selecting a subset of relevant features for use in model construction); dimensionality reduction (e.g., a process of reducing a number of random variables under consideration); normalization (e.g., adjusting values measured on different scales to a common scale); data subsetting (e.g., retrieving portions of data that are of interest for a specific purpose); or the like.

As further shown in FIG. 6, process 600 may include performing an analysis of the healthcare information, the location information, and/or the demographic information (block 620). For example, wellness server 230 may perform an analysis of the healthcare information, the location information, and/or the demographic information (e.g., the user information) in near real time, real time, or batch time, via analytics techniques, such as pattern recognition, hidden Markov modeling, trending, prediction, segregation, or the like. Performance of the analysis in real time may include wellness server 230 receiving the user information, processing the user information, and generating analysis information so that the user information may be utilized within a particular time (e.g., in milliseconds, microseconds, seconds, or the like) of receiving the user information. Performance of the analysis in near real time may include the particular time associated with a real time analysis less a time required for wellness server 230 to generate the analysis information based on the user information. In some implementations, wellness server 230 may perform an analysis of the healthcare information over time (e.g., not in real time or near real time).

In some implementations, wellness server 230 may utilize pattern recognition techniques to identify wellness behavior of the user based on the user information. Pattern recognition may generally include recognition of patterns and regularities in data. Pattern recognition systems may be trained from labeled training data (e.g., supervised learning), but when no training data is available, may utilize algorithms to discover previously unknown patterns (e.g., unsupervised learning). In some implementations, wellness server 230 may utilize unsupervised pattern recognition techniques, supervised pattern recognition techniques, or semi-supervised pattern recognition techniques to identify wellness behavior of the user based on the user information. The pattern recognition may enable wellness server 230 to provide health-related motivations that encourage the user to live a healthier lifestyle.

In some implementations, wellness server 230 may utilize pattern recognition to identify items, events, or observations that conform to an expected pattern or other items, events, or observations in a dataset. In some implementations, wellness server 230 may determine normal wellness behavior patterns associated with the user, over time and based on the user information. For example, wellness server 230 may determine that the user jogs at least twenty kilometers each week, that the user is overweight, that the user purchases unhealthy foods at the supermarket (e.g., via virtual wallet purchases), that the user eats fast food at least three times each week (e.g., via virtual wallet purchases), that the user has high blood pressure, that the user experiences irregular breathing patterns, or the like.

In some implementations, wellness server 230 may utilize hidden Markov modeling techniques to determine wellness behavior of the user based on the user information. A hidden Markov model may generally include a statistical Markov model in which a system being modeled is assumed to be a Markov process with unobserved (or hidden) states. A hidden Markov model may include the simplest dynamic Bayesian network, and may be used in temporal pattern recognition, such as speech recognition, handwriting recognition, gesture recognition, or the like. In some implementations, wellness server 230 may utilize hidden Markov modeling techniques to identify wellness behavior of the user based on the user information. For example, wellness server 230 may determine that the user has high cholesterol, that the user is an ideal weight, that the user runs at least ten kilometers each week, or the like. In some implementations, the hidden Markov modeling techniques may enable wellness server 230 to provide health-related motivations that encourage the user to live a healthier lifestyle.

In some implementations, wellness server 230 may utilize trending techniques (or trend analysis) to determine wellness behavior of the user based on the user information. Trending techniques may generally include collecting information and attempting to determine a pattern, or a trend, in the information. Trending techniques may be used to predict future events and/or to estimate uncertain events in the past. In some implementations, wellness server 230 may analyze the user information, for a particular time period, in order to identify the trends in the user information and/or the wellness behavior of the user. For example, wellness server 230 may determine that the user is slowly gaining weight based on the trending techniques. The trending technique may enable wellness server 230 to provide health-related motivations that encourage the user to live a healthier lifestyle.

In some implementations, wellness server 230 may utilize prediction techniques (or predictive analytics) to determine one or more future wellness behavior of the user based on the user information. Prediction techniques may generally include a variety of techniques (e.g., statistics, modeling, machine learning, data mining, or the like) that analyze current and historical information to make predictions about future, or otherwise unknown, events. In some implementations, wellness server 230 may determine normal wellness behavior patterns associated with the user, over time and based on the user information. Wellness server 230 may utilize the determined normal wellness behavior patterns in order to predict future wellness behavior of the user. For example, wellness server 230 may predict that the user will have high blood pressure in three years if the user continues to smoke. The prediction techniques may enable wellness server 230 to provide health-related motivations that encourage the user to live a healthier lifestyle.

In some implementations, wellness server 230 may utilize segmentation techniques to determine groups of users that are similar in wellness behavior (e.g., similar users may have similar characteristics, conditions, or the like). Segmentation techniques may generally include dividing or clustering items into groups that are similar in specific ways relevant to the items, such as the behavior of the items. In some implementations, wellness server 230 may analyze the user information and user information received from other user devices 220, for a particular time period, in order to identify similarities in the user information. Wellness server 230 may utilize the determined similarities to group users into groups of users with similar wellness behavior. In some implementations, wellness server 230 may analyze the user information and user information received from other user devices 220, for a particular time period, in order to determine correlations between different types of user information (e.g., between the healthcare information and the location information, between the location information and the demographic information, or the like). The segmentation technique may enable wellness server 230 to provide health-related motivations that encourage the user to live a healthier lifestyle.

In some implementations, wellness server 230 may perform the analysis of the user information via the pattern recognition techniques, the Markov modeling techniques, the trending techniques, the prediction techniques, the segregation techniques, and/or other analytics techniques. In some implementations, a user of user device 220 may specify which analytics techniques to perform on the healthcare information. In some implementations, a number and types of analytics techniques performed by wellness server 230 on the user information may be based on a type of account of the user, processing power of wellness server 230, an amount of money paid by the user, or the like. In some implementations, wellness server 230 may utilize multiple analytics techniques to generate multiple scores (or values that may be weighted) associated with a wellness of the user, and may combine the scores together to get a final wellness score for the user.

As further shown in FIG. 6, process 600 may include generating a health-related incentive, health-related gaming information, and/or health-related coaching information based on the analysis of the healthcare information, the location information, and/or the demographic information (block 630). For example, wellness server 230 may generate a health-related incentive, health-related gaming information, and/or health-related coaching information based on the analysis of the user information (e.g., the healthcare information, the location information, and/or the demographic information) associated with the user of user device 220. In some implementations, the health-related incentive, the health-related gaming information, and/or the health-related coaching information may include information generated by performance of the pattern recognition technique, the Markov modeling technique, the trending technique, the prediction technique, and/or the segmentation technique by wellness server 230. In some implementations, wellness server 230 may store the health-related incentive, the health-related gaming information, and/or the health-related coaching information in memory (e.g., memory 330, FIG. 3) associated with wellness server 230.

In some implementations, the health-related incentive may include an incentive to modify the behavior of the user so that the user incrementally moves toward a healthier lifestyle. In some implementations, the health-related incentive may include a monetary health-related incentive, such as a gift card, an insurance premium reduction, a subsidy from an employer, a third party, and/or an insurer, or the like. In some implementations, the health-related incentive may include a non-monetary health-related incentive, such as points for doing something the user enjoys, a free user device, a gym membership, access to a new fitness game, or the like.

In some implementations, the health-related incentive may be personalized for the user and include a story (e.g., a video, images, a game, or the like) that motivates the user to achieve a healthier lifestyle. The story may take different paths depending on the actions taken by the user and/or may diverge even after the same action is taken by the user (e.g., traversing a same route when walking or running, doing a predetermined number of crunches, or the like). In some implementations, monitoring devices 210 and/or sensors in user device 220 may automatically trigger and/or launch augmented interactions to provide story continuity. The health-related incentive may include variations in the story that may be controllable by the user or by various members of the user's community. In some implementations, wellness server 230 may enable an entity (e.g., an employer, an insurer, a healthcare provider, or the like) to purchase control of the story or health-related incentives associated with the story. In some implementations, the story may be the same for users performing the same activity at the same time and/or at the same location. In some implementations, the story may be personalized in real-time for the user based on the user's preferences provided for the wellness application (e.g., stored in user device 220 or determined from history or online interactions).

In some implementations, the health-related incentive may include an incentive to address the user's mental wellness issues rather than the user's physical wellness issues. Mental wellness issues may include psychological issues, such as a gambling problem, a spending problem, depression, anxiety, or the like. In some implementations, the health-related incentive may include awarding the user a point(s) based on a particular action taken by the user. Points may be awarded based on actions (e.g., taking medicine at a regularly scheduled time) or deducted based on non-actions (e.g., failing to exercise one day).

In some implementations, the health-related incentive may be sponsored by any number of entities associated or not associated with the user (e.g., friends, family, third parties such as companies promoting goods or services, an employer, a healthcare provider, a public or private health initiative promoting community health, or the like). In some implementations, the health-related incentive may be provided by a trusted source, such as parents, grandparents, or the like, to the user. In some implementations, the health-related incentive may encourage small gains in the wellness behavior of the user, as opposed to large drastic changes in the wellness behavior. Thus, the health-related incentive may enable family members and/or friends to encourage users with problematic wellness behavior toward a healthier lifestyle (e.g., parents may utilize the wellness application to encourage teenagers to consume healthy foods and prevent obesity).

In some implementations, the health-related gaming information may include a wellness game, a fitness game, levels achieved in the wellness game and/or fitness game, or the like. In some implementations, the health-related gaming information may include a link between levels of the wellness game and/or the fitness game and the health-related incentive generated by wellness server 230. In some implementations, the health-related gaming information may be shared with users of other user devices 220, may be posted in real time on a social network (e.g., based on a cloud connection or a persistent connection), or the like. This may permit interested parties related to the user (e.g., social network friends, co-workers, or the like) to keep track of the user, and may provide information about the user's progress to competitors in a fitness application/game or other parties interested in the fitness application/game.

In some implementations, various mechanisms may be used to update and/or post the user's progress to a user's account (e.g., a gaming account, a social media account, or the like), such as automatic updating and/or posting the user's progress (e.g., once a trigger and/or milestone is reached), manually updating and/or posting the user's progress, or the like. In some implementations, the fitness application/game may be utilized by the user (e.g., an individual), may be utilized by teams, and/or may share the health-related gaming information with other users. In some implementations, different types of posts of the user's progress may occur depending on a recipient of the post. For example, the user's progress may be posted to teammates after each event of the fitness application/game or a first amount of time (e.g., in minutes) after each event. The user's progress may be posted to family members a second amount of time (e.g., in days) after each event, and may be posted to a health website a third amount of time (e.g., in weeks or months) after each event. In some implementations, different portions of the user's progress may be provided to different recipients of the post (e.g., limitations may be placed on the post based on parental controls).

In some implementations, the health-related coaching information may include information provided by a virtual wellness coach or a real wellness coach (e.g., a physician, a nutritionist, a personal trainer, a group of coaches, a fitness professional, or the like). In some implementations, the health-related coaching information may include a wellness recommendation, such as a correct way to weight train, provided by the virtual or the real wellness coach, a type of wearable device the user should buy, or the like. In some implementations, the health-related coaching information may include information that changes the user's wellness behavior, health-related information that provides advice about various activities that the user is engaging in or may engage in, or the like. In some implementations, the health-related coaching information may include personal information (e.g., how often the user eats at a particular fast food restaurant); non-personal information (e.g., how close the user is to the fast food restaurant, how many calories are in a typical meal from the restaurant, what kind of workout would be required to burn those calories, or the like); alerts (e.g., instructing the user to use a staircase); food information (e.g., a diet, a portion size, or the like); exercise information (e.g., a personal workout for the user each day); or the like. In some implementations, the health-related coaching information may include positive information (e.g., reaching a goal distance or weight) or negative information (e.g., eating candy will cause weight gain).

In some implementations, wellness server 230 may determine an overall health score for the user based on the analysis of the user information. In some implementations, wellness server 230 may combine the results of the different analytics techniques (e.g., the pattern recognition technique, the Markov modeling technique, the trending technique, the prediction technique, and/or the segmentation technique) together to generate the overall health score for the user. In some implementations, wellness server 230 may assign weights to different results of the different analytics techniques, and may combine the weighted results together to generate the overall health score for the user. In some implementations, the overall health score of the user may be similar to a body mass index (BMI), but may be determined based on more variables than merely a height and a weight of the user.

In some implementations, wellness server 230 may determine analysis information based on the analysis of the user information. In some implementations, the analysis information may include information identifying patterns in the user information (e.g., readings from particular monitoring devices 210 may be unusually high); information identifying trends associated with the user information (e.g., the user information may indicate that a user is experiencing increased blood pressure due to an increase in weight); information identifying comparisons between similar users (e.g., the user information associated with a first user may be compared with the user information associated with a second user); information identifying predictions for the user (e.g., the user information may indicate that the user may need to have heart surgery in one year); or the like.

In some implementations, the analysis information may include a comparison of analyzed information, associated with a first user, and analyzed information, associated with a second user similar to the first user. Such implementations may enable an entity (e.g., a healthcare provider) to determine how the health of the first user compares with the health of the second user, and vice versa. In some implementations, wellness server 230 may process the analysis information by filtering patterns in the analysis information, performing visualization on the analysis information, interpreting patterns in the analysis information, or the like.

In some implementations, wellness server 230 may determine scores for health-related motivations, such as health-related incentives, health-related gaming information, health-related coaching information, or the like based on the analysis of the user information with the different analytics techniques (e.g., the pattern recognition technique, the Markov modeling technique, the trending technique, the prediction technique, and/or the segmentation technique). In some implementations, wellness server 230 may select one or more health-related incentives based on a threshold. For example, assume that wellness server 230 identifies three health-related incentives for the user (e.g., a gift card to a gym, a free device, and lower insurance premium), and scores the gift card with a score of 0.9, the free device with a score of 0.3, and the lower insurance premium with a score of 0.6. Further, assume that wellness server 230 selects health-related incentives with scores greater than a threshold of 0.5. In such an example, wellness server 230 may select the gift card and the lower insurance premium (but not the free device) since these incentives satisfy the threshold. In some implementations, if multiple analytics techniques are utilized, wellness server 230 may combine the scores from each of the techniques in order to determine the scores for health-related motivations.

As further shown in FIG. 6, process 600 may include providing the health-related incentive, the health-related gaming information, and/or the health-related coaching information for display to the user device (block 640). For example, wellness server 230 may provide the health-related incentive, the health-related gaming information, and/or the health-related coaching information, for display, to user device 220 associated the user and/or user devices 220 associated with other users. In some implementations, wellness server 230 may provide the health-related incentive, the health-related gaming information, and/or the health-related coaching information, for display, to multiple user devices 220 associated the user. For example, assume that the wellness application is provided on a tablet computer associated with the user, and that the user utilizes a gaming system to play a fitness game. In such an example, wellness server 230 may provide the health-related gaming information to the user's smart phone and the user's gaming system. In some implementations, the wellness application may enable user device 220 (e.g., a smart phone) to interact with other devices associated with the user, such as wearable devices, a gaming system provided in the user's home, a television provided in the user's home, equipment provided at gyms (e.g., a treadmill), or the like. In some implementations, the wellness application may provide a seamless combination of home wellness information (e.g., provided by a wearable device, a gaming system provided in the user's home, calorie counter provided on the user's smart phone, or the like) and external wellness information (e.g., a number of miles jogged by the user on a treadmill at a gym).

In some implementations, the health-related incentive, the health-related gaming information, and/or the health-related coaching information may be provided to the user via visual feedback, audible feedback, tactile feedback, monetary feedback, non-monetary feedback, or a combination of visual, audible, tactile, monetary, and/or non-monetary feedback. In some implementations, the health-related incentive, the health-related gaming information, and/or the health-related coaching information may be provided to the user based on various user actions and/or inactions. In some implementations, wellness server 230 may periodically provide the health-related incentive, the health-related gaming information, and/or the health-related coaching information to user device 220. In some implementations, wellness server 230 may continuously provide the health-related incentive, the health-related gaming information, and/or the health-related coaching information to user device 220. In some implementations, wellness server 230 may provide the health-related incentive, the health-related gaming information, and/or the health-related coaching information to user device 220 when requested by the user. In some implementations, the health-related incentive, the health-related gaming information, and/or the health-related coaching information may comply with particular regulations (e.g., HIPAA regulations).

In some implementations, the health-related incentive, the health-related gaming information, and/or the health-related coaching information may aid an entity (e.g., the user, a healthcare provider, an employer, or the like) in daily management of the user's wellness, and may enable the entity to make decisions associated with the user's wellness. In some implementations, the health-related incentive, the health-related gaming information, and/or the health-related coaching information may enable the entity to control healthcare costs associated with the user by alerting the entity about problems with the user, by encouraging the user to engage in healthier behavior, or the like.

In some implementations, wellness server 230 may perform the analysis of the user information, and may identify a type of health-related motivation (e.g., health-related incentive, health-related gaming information, health-related coaching information, or the like) based on performing the analysis. Wellness server 230 may determine an amount associated with the type of health-related motivation (e.g., a $25 gift card versus a $50 gift card, a coach for two days a week versus a coach for five days a week, or the like), and may provide the determine amount of the type of health-related motivation to the user (e.g., via user device 220).

In some implementations, wellness server 230 may communicate with other devices in order to implement a health-related motivation. For example, wellness server 230 may instruct a locking mechanism on a refrigerator or other container containing food or other desirables to remain locked until a goal is attained. In another example, wellness server 230 may prevent access to an area such as a lounge, a game room, an entertainment system (e.g., at home or away) until a goal is attained. In still another example, wellness server 230 may unlock exercise equipment functionality (e.g., access to television programming, new treadmill patterns, or the like) when a goal is attained.

In some implementations, wellness server 230 may personalize applications, rewards, gaming, or the like in order to retain and engage users by offering incentives that the user cares about. In some implementations, wellness server 230 may modify the behavior of a user via a mobile user device 220 (e.g., a smart phone) that is almost always with the user. In some implementations, the smart phone may execute a background application (e.g., either separately or within the wellness application) that gathers location information associated with the user. The location information may be used by wellness server 230 to determine the real time behavior of the user (e.g., the user is at a fast food restaurant purchasing unhealthy food), and may be a source of behavior analysis when combined with location information associated with retail stores, food services, and/or other key indicators. In some implementations, wellness server 230 may provide cloud based massively multiplayer online gaming services in order to create real interactive and customized competitions with coaches and/or other users. Such massively multiplayer online gaming services may be a source of substantial wellness benefits if combined with social networking, closed user groups, and/or other media tools.

As further shown in FIG. 6, process 600 may include determining whether a health-related behavior of the user is modified based on the health-related incentive, the health-related gaming information, and/or the health-related coaching information (block 650). For example, wellness server 230 may determine whether a health-related behavior of the user is modified based on the health-related incentive, the health-related gaming information, and/or the health-related coaching information. In some implementations, wellness server 230 may receive additional user information, after providing the health-related incentive, the health-related gaming information, and/or the health-related coaching information to user device 220, and may utilize the additional user information to determine whether the user's health-related behavior has been modified.

For example, assume that wellness server 230 provides a free gym membership to the user (e.g., as a health-related incentive) in order to encourage the user to work out. In such an example, wellness server 230 may determine after a particular period of time (e.g., a day, a week, or the like) whether the user is utilizing the free gym membership (e.g., based on the user's location information, records from the gym, or the like). If wellness server 230 determines that the user is not utilizing the free gym membership, wellness server 230 may determine that the user's wellness behavior has not been modified (i.e., the user is still not working out). When the free gym membership does not work, wellness server 230 may try other health-related motivations different that the free gym membership. If wellness server 230 determines that the user is utilizing the free gym membership, wellness server 230 may determine that the user's wellness behavior has been modified (i.e., the user is working out). When the free gym membership works, wellness server 230 may try other health-related motivation similar to the free gym membership.

As further shown in FIG. 6, process 600 may include modifying the health-related incentive, the health-related gaming information, and/or the health-related coaching information when the health-related behavior of the user is not modified (block 660). For example, wellness server 230 may modify the health-related gaming information, and/or the health-related coaching information when wellness server 230 determines that the health-related behavior of the user is not modified. In some implementations, wellness server 230 may re-perform the analysis of the user information and any updated user information (e.g., as described above in connection with process block 620), and may identify and/or select a modified health-related incentive, modified health-related gaming information, and/or modified health-related coaching information based on the re-performed analysis (e.g., as described above in connection with process block 630).

For example, assume that wellness server 230 instructs the user to run one kilometer each day (e.g., health-related coaching information) based on the analysis of the user information. Further, assume that the user runs one kilometer every other day based on the instruction received from wellness server 230. In such an example, wellness server 230 may determine that health-related behavior of the user is partially modified, but may wish to still encourage the user to run on a daily basis. Thus, wellness server 230 may instruct the user to run at 0.5 kilometers or more each day (e.g., modified health-related coaching information) so that the user is running on a daily basis.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

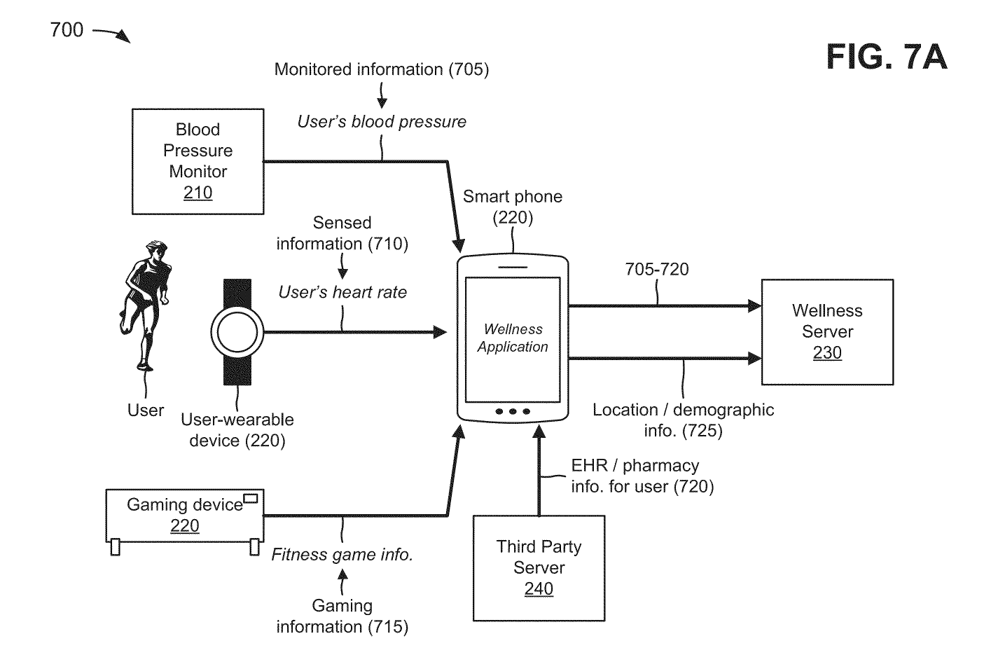

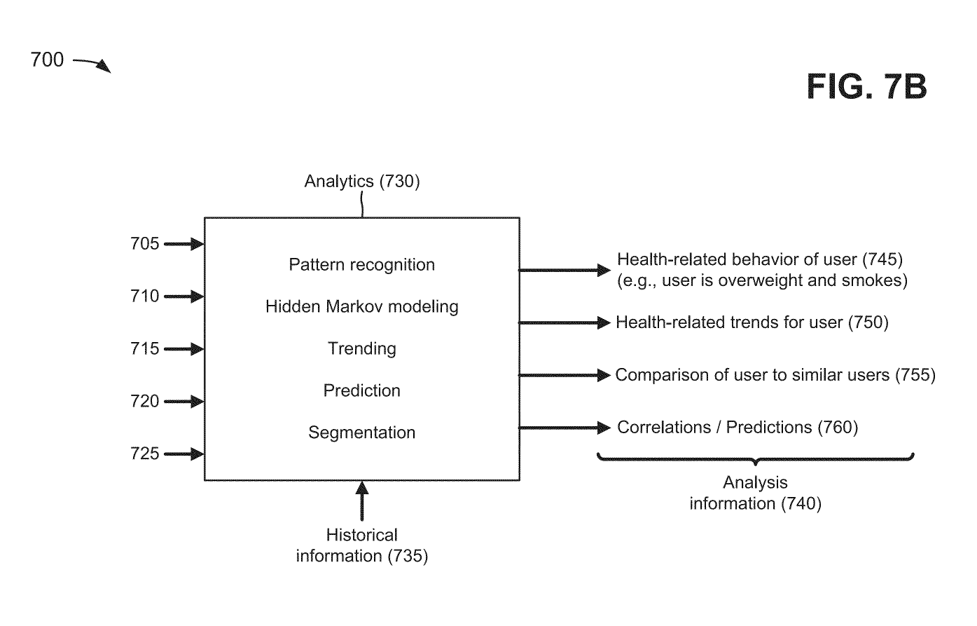

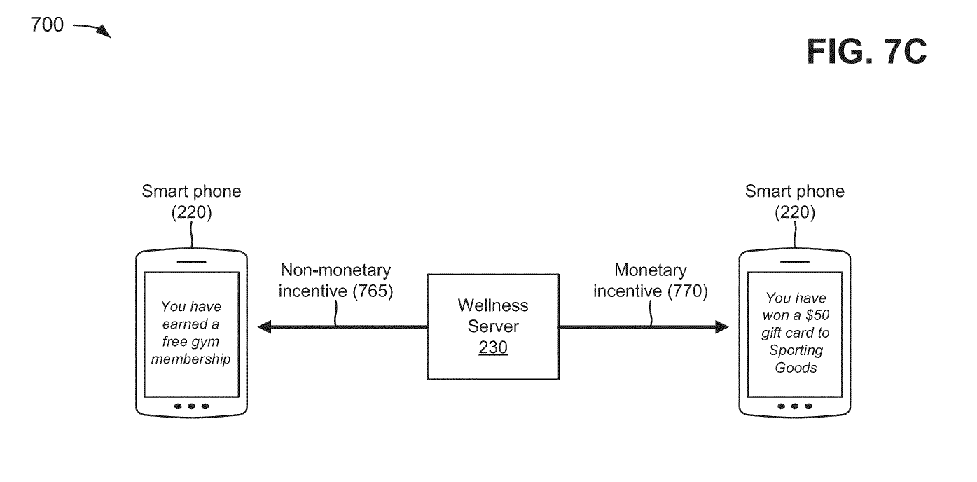

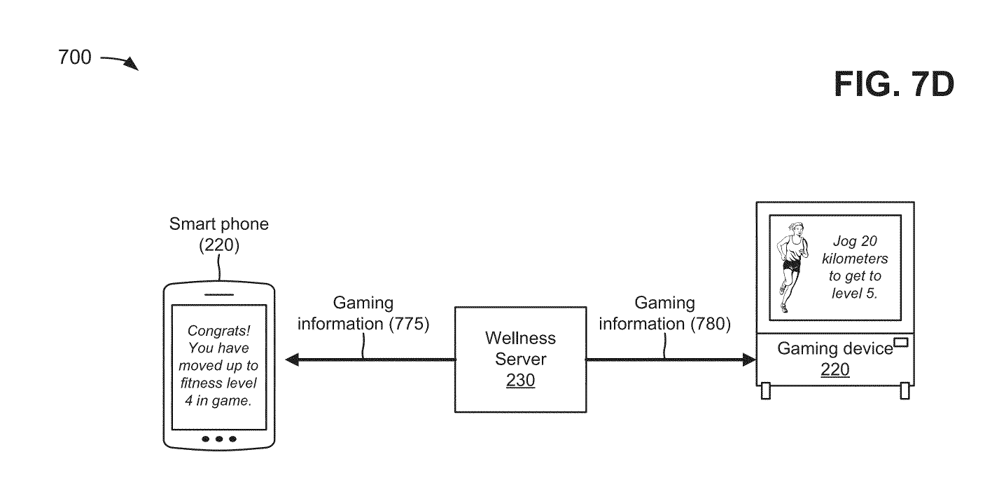

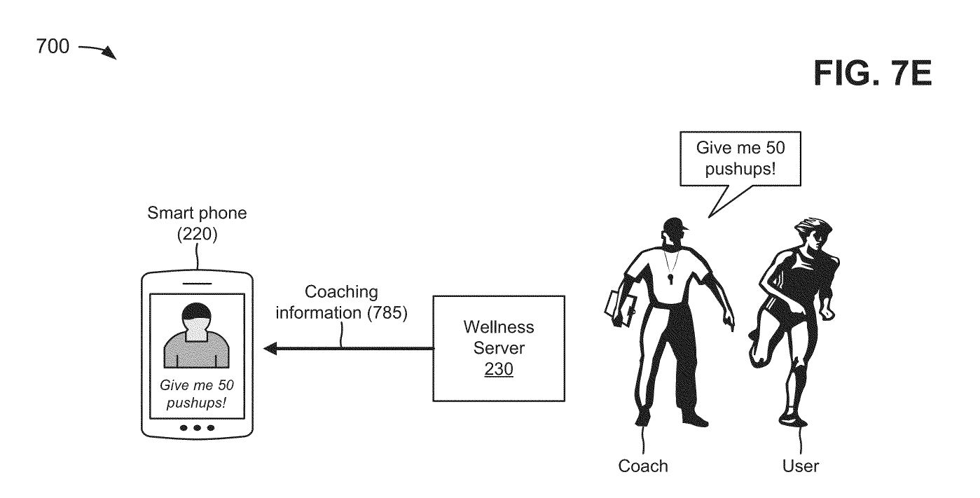

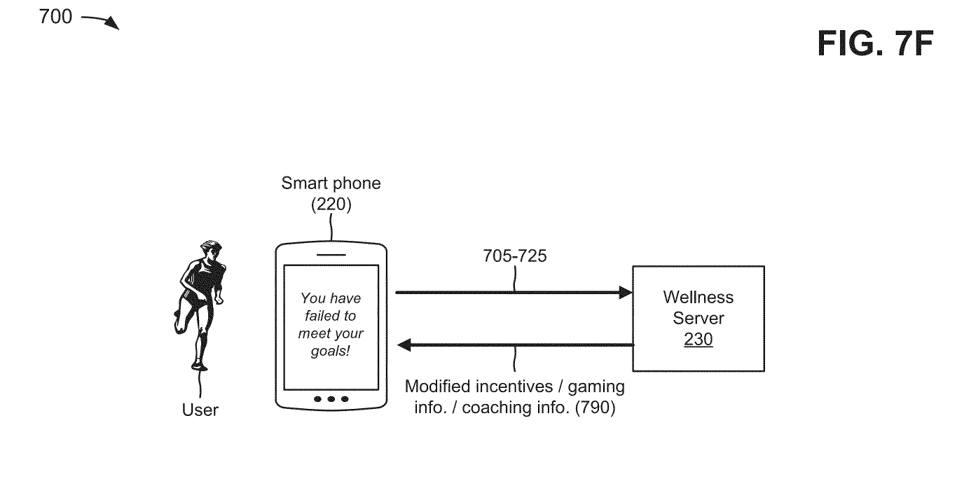

FIGS. 7A-7F are diagrams of an example 700 relating to example process 600 shown in FIG. 6. As shown in FIG. 7A, assume that a monitoring device 210 (e.g., a blood pressure monitor 210) and/or multiple user devices 220 (e.g., a user-wearable device 220, a gaming device 220, and a smart phone 220) are associated with a user, and that the wellness application is provided on smart phone 220. Blood pressure monitor 210 may generate monitored information 705 (e.g., a blood pressure of the user) based on operation of blood pressure monitor 210, and may provide monitored information 705 to smart phone 220. User-wearable device 220 (or smart phone 220) may generate sensed information 710 (e.g., a heart rate of the user) based on operation of user-wearable device 220, and may provide sensed information 710 to smart phone 220. Gaming device 220 may generate gaming information 715 (e.g., fitness game information) based on the user utilizing gaming device 220, and may provide gaming information 715 to smart phone 220.

As further shown in FIG. 7A, third party server 240 may store an EHR and pharmacy information 720 for the user, and may provide EHR/pharmacy information 720 to smart phone 220. EHR 720 may include healthcare information associated with the user and collected by one or more healthcare providers. Pharmacy information 720 may include a list of medications to be taken by the user, dosages associated with the medications, frequencies that the medications are taken by the user, or the like. Furthermore, smart phone 220 may generate location information 725 associated with smart phone 220 and/or demographic information 725 associated with the user. The wellness application may cause smart phone 220 to receive monitored information 705, sensed information 710, gaming information 715, EHR/pharmacy information 720, and/or location/demographic information 725. The wellness application may also cause smart phone 220 to provide monitored information 705, sensed information 710, gaming information 715, EHR/pharmacy information 720, and/or location/demographic information 725 to wellness server 230, as further shown in FIG. 7A.

As shown in FIG. 7B, wellness server 230 may include an analytics component 730 that receives monitored information 705, sensed information 710, gaming information 715, EHR/pharmacy information 720, location/demographic information 725, and/or historical information 735 (e.g., historical monitored information 705, sensed information 710, gaming information 715, EHR/pharmacy information 720, location/demographic information 725, or the like). Analytics component 730 may perform analytics techniques (e.g., pattern recognition, hidden Markov modeling, trending, prediction, segmentation, or the like) on monitored information 705, sensed information 710, gaming information 715, EHR/pharmacy information 720, location/demographic information 725, and/or historical information 735 to generate analysis information 740.

As further shown in FIG. 7B, analysis information 740 may include a health-related behavior 745 of the user (e.g., the user is overweight and smokes); health-related trends 750 associated with the user; comparisons 755 of the user's wellness with the wellness of similar users; correlations and/or predictions 760 based on monitored information 705, sensed information 710, gaming information 715, EHR/pharmacy information 720, location/demographic information 725, and/or historical information 735; or the like. In some implementations, wellness server 230 may utilize analysis information 740 to identify health-related incentives, health-related gaming information, and/or health-related coaching information for the user.

For example, as shown in FIG. 7C, wellness server 230 may generate a non-monetary health-related incentive 765 for the user, and may provide non-monetary health-related incentive 765, for display, to smart phone 220. Non-monetary health-related incentive 765 may indicate that the user has earned a free gym membership based on the user's wellness behavior. As further shown in FIG. 7C, wellness server 230 may generate a monetary health-related incentive 770 for the user, and may provide monetary health-related incentive 770, for display, to smart phone 220. Monetary health-related incentive 770 may indicate that the user has won a $50 gift card to a sporting goods store based on the user's wellness behavior.

As shown in FIG. 7D, wellness server 230 may generate gaming information 775 for the user, and may provide gaming information 775, for display, to smart phone 220. Gaming information 775 may indicate that the user has moved up to fitness level four (4) in a fitness game based on the user's wellness behavior. As further shown in FIG. 7D, wellness server 230 may generate other gaming information 780 for the user, and may provide other gaming information 780, for display (e.g., via a display device), to gaming device 220. Gaming information 780 may indicate that the user needs to jog twenty (20) kilometers to achieve fitness level five (5) of the fitness game.

As shown in FIG. 7E, wellness server 230 may generate coaching information 785 for the user, and may provide coaching information 785, for display (e.g., via a virtual coach), to smart phone 220. Coaching information 785 may display the virtual coach, and the virtual coach may instruct the user to perform fifty (50) pushups. As further shown in FIG. 7E, wellness server 230 may cause a real coach to personally visit the user and instruct the user perform fifty (50) pushups.

As shown in FIG. 7F, wellness server 230 may receive updates to monitored information 705, sensed information 710, gaming information 715, EHR/pharmacy information 720, location/demographic information 725, and may determine whether the user's wellness behavior has been modified based on the updates. If the user's wellness behavior has not been modified, wellness server 230 may generate modified health-related incentives, gaming information, and/or coaching information 790, and may provide modified health-related incentives, gaming information, and/or coaching information 790 to smart phone 220. Modified health-related incentives, gaming information, and/or coaching information 790 may indicate that the user has failed to meet the user's goals, and may instruct the user on how achieve the user's goals.

As indicated above, FIGS. 7A-7F are provided merely as an example. Other examples are possible and may differ from what was described with regard to FIGS. 7A-7F. In some implementations, the various operations described in connection with FIGS. 7A-7F may be performed automatically or at the request of a user.

Systems and/or methods, described herein, may provide a framework for modifying wellness behavior of a user. The systems and/or methods may provide a single location for storage and retrieval of healthcare information associated with the user, and may provide monetary and non-monetary incentives to motivate the user to engage in healthy behavior. The systems and/or methods may provide real or virtual health coaching to further motivate the user to engage in healthy behavior, and may utilize gaming to create health-related competition for the user with other users. By improving the wellness of the user, the systems and/or methods may significantly reduce healthcare costs for users, employers of the users, healthcare providers, insurance providers, or the like.

To the extent the aforementioned implementations collect, store, or employ personal information provided by individuals, it should be understood that such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The foregoing disclosure provides illustration and description, but is not intended to be exhaustive or to limit the implementations to the precise form disclosed. Modifications and variations are possible in light of the above disclosure or may be acquired from practice of the implementations.

A component is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method, comprising:
receiving, by a device, healthcare information associated with a user,
the healthcare information including information associated with a health of the user, the information being received from a plurality of devices that monitor the health of the user or store information regarding the health of the user;
performing, by the device, an analysis of the healthcare information via one or more analytics techniques;
identifying, by the device, a type of health-related motivation, from a plurality of types of health-related motivations, based on performing the analysis; and
providing, by the device, the type of health-related motivation to a user device associated with the user.

2. The method of claim 1, further comprising:
determining whether a health-related behavior of the user is modified based on the type of health-related motivation;
identifying another type of health-related motivation, from the plurality of types of health-related motivations, when the health-related behavior of the user is not modified; and
providing the other type of health-related motivation to the user device.

3. The method of claim 1, where the type of health-related motivation includes:
a monetary health-related incentive, or
a non-monetary health-related incentive.

4. The method of claim 1, where the type of health-related motivation includes:
health-related gaming information that includes information associated with a fitness game played by the user, or
health-related coaching information that includes information provided by a virtual health coach.

5. The method of claim 1, where the one or more analytics techniques include two or more of:
a pattern recognition technique to identify patterns in a health-related behavior of the user based on the healthcare information,
a hidden Markov modeling technique to determine the health-related behavior of the user based on the healthcare information,
a trending technique to identify one or more trends in the health-related behavior of the user based on the healthcare information,
a prediction technique to predict one or more future health-related behaviors of the user based on the healthcare information, or
a segmentation technique to group the user, with a plurality of similar users, based on the healthcare information.

6. The method of claim 1, further comprising:
assigning weights to information determined by the one or more analytics techniques; and
calculating a health score for the user based on the assigned weights and the information determined by the one or more analytics techniques.

7. The method of claim 6, further comprising:
identifying the type of health-related motivation from the plurality of types of health-related motivations, based on the health score for the user.

8. A device, comprising:
one or more processors to:
receive user information associated with a user of a user device,
the user information including:
healthcare information associated with the user,
location information associated with the user, and
demographic information associated with the user;
perform an analysis of the user information via one or more analytics techniques;
identify a type of health-related motivation, from a plurality of types of health-related motivations, based on performing the analysis; and
provide the type of health-related motivation to the user device associated with the user.

9. The device of claim 8, where the one or more processors are further to:
determine whether a health-related behavior of the user is modified based on the type of health-related motivation; and
identify another type of health-related motivation, from the plurality of types of health-related motivations, when the health-related behavior of the user is not modified.

10. The device of claim 8, where the type of health-related motivation includes a health-related incentive to incrementally modify a wellness behavior of the user.

11. The device of claim 8, where the type of health-related motivation includes health-related gaming information that includes information associated with a fitness game played by the user, and the one or more processors are further to:
share the health-related gaming information with other users playing the fitness game.

12. The device of claim 8, where the type of health-related motivation includes health-related coaching information that includes fitness instructions provided by a health coach.

13. The device of claim 8, where the one or more processors are further to:
assign weights to information determined by the one or more analytics techniques;
calculate an overall health score for the user based on the assigned weights and the information determined by the one or more analytics techniques; and
provide the overall health score to the user device.

14. The device of claim 13, where the one or more processors are further to:
identify the type of health-related motivation, from the plurality of types of health-related motivations, based on the overall health score for the user.

15. A computer-readable medium for storing instructions, the instructions comprising:
one or more instructions that, when executed by one or more processors of a device, cause the one or more processors to:
receive user information associated with a user,
the user information including:
healthcare information associated with the user, the healthcare information being received from a plurality of devices that monitor a health of the user or store information regarding the health of the user,
location information associated with the user, and
demographic information associated with the user;
perform an analysis of the user information via one or more analytics techniques;
identify a type of health-related motivation, from a plurality of types of health-related motivations, based on performing the analysis; and
provide the type of health-related motivation to a user device associated with the user.

16. The computer-readable medium of claim 15, where the plurality of devices that monitor a health of the user include at least one of:
a monitoring device that monitors vital signs of the user,
a wearable user device that monitors the vital signs of the user,
a gaming device that provides a fitness game for the user,
a user device that receives the information associated with the health of the user from a server device.

17. The computer-readable medium of claim 15, where the one or more instructions, when executed by the one or more processors, further cause the one or more processors to:
determine whether a health-related behavior of the user is modified based on the type of health-related motivation; and
identify another type of health-related motivation, from the plurality of types of health-related motivations, when the health-related behavior of the user is not modified; and
provide the other type of health-related motivation to the user device.

18. The computer-readable medium of claim 15, where the type of health-related motivation includes one of:
a monetary health-related incentive that is predicted to incrementally modify a health-related behavior of the user, or
a non-monetary health-related incentive that is predicted to incrementally modify the health-related behavior of the user.

19. The computer-readable medium of claim 15, where the type of health-related motivation includes:
health-related gaming information that includes information associated with a fitness game played by the user, or
health-related coaching information that includes information provided by a health coach.

20. The computer-readable medium of claim 15, where the one or more instructions, when executed by the one or more processors, further cause the one or more processors to:
assign weights to information determined by the one or more analytics techniques;
calculate a health score for the user based on the assigned weights and the information determined by the one or more analytics techniques;
identify the type of health-related motivation, from the plurality of types of health-related motivations, based on the health score for the user; and
provide the health score to the user device.
